(19) United States
(12) Patent Application Publication
(10) Pub. No.: US 2013/0094070 A1
(43) Pub. Date: Apr. 18, 2013

(54) Optological Gates

(71) Applicant: Shahin Mojtabaee Tabatabaee, Tehran (IR)

(72) Inventor: Shahin Mojtabaee Tabatabaee, Tehran (IR)

(21) Appl. No.: 13/209,604

(22) Filed: Oct. 13, 2011

(51) Int. Cl. G02F 3/00

(52) U.S. Cl. 359/108

(57) ABSTRACT

In this invention truth logic is defined as that “Light existence=TRUE” and “NO light or Dark=FALSE”. And through the optical principles (: “Fraunhofer” single slit & “Young” double slits light diffraction pattern), I have designed logical function gates (AND, OR, XOR & NOT), using the optical equipments and a coherent light beam (Laser beam), with no interference of any electronic circuits or devices. This design would lead us to make Optological Gates which run at the light speed, so we would have logical function gates with very high speed.

### SUMMARY OF THE INVENTION

In this invention truth logic is defined as that “Light existence=TRUE” and “NO light or Dark=FALSE”. And through the optical principles (: “Fraunhofer” single slit & “Young” double slits light diffraction pattern), I have designed logical function gates (AND, OR, XOR & NOT), using the optical equipments and a coherent light beam (Laser beam), with no interference of any electronic circuits or devices. This design would lead us to make Optological Gates which run at the light speed, so we would have logical function gates with very high speed.

### DESCRIPTION OF DRAWINGS

FIG. 1: “Fraunhofer” Single Slit light diffraction principle

FIG. 2: Single slit diffraction pattern of the light beam with the wavelength=600 nm and width of slit=2500 nm.

FIG. 3: “Young” double Slit, light diffraction principle

FIG. 4: Double slits diffraction pattern of the light beam with the wavelength=600 nm and width of spacing between slits=5000 nm

FIG. 5: Double slits (Named “A” & “B”), each slit posit as a logical input

FIG. 6: Light pattern while covering double slits with black sheet, No light would pass through and the screen of the light diffraction pattern would be DARK.

FIG. 7: Light diffraction pattern while covering one slit (“A” slit) with black sheet, so the diffraction pattern would follow the single slit diffraction pattern.

FIG. 8: Light diffraction pattern while covering one slit (“B” slit) with black sheet, so the diffraction pattern would follow the single slit diffraction pattern.

FIG. 9: First maximum intensity in double slits light diffraction pattern at “0°”

FIG. 10: First maximum intensity in double slits light diffraction pattern at “0°” shown in flat pattern

FIG. 11: First maximum intensity in single slit light diffraction pattern at “0°”

FIG. 12: First maximum intensity in single slit light diffraction pattern at “0°” shown in flat pattern

FIG. 13: OR logical function slit at “0°” of light diffraction pattern

FIG. 14: OR logical function slit, truth table, truth logic is defined as that “Light existence=TRUE” and “NO light or Dark=FALSE”

FIG. 15: First minimum intensity in double slits light diffraction pattern at “±3.4°”

FIG. 16: First minimum intensity in single slits light diffraction pattern at “±3.4°” shown in flat pattern

FIG. 17: The light intensity in single slit light diffraction pattern at “±3.4°” is “0.8≈maximum”

FIG. 18: The light intensity in single slit light diffraction pattern at “±3.4°” is “0.8≈maximum”, shown in flat pattern

FIG. 19: XOR logical function slit at “3.4°” of light diffraction pattern

FIG. 20: XOR logical function slit truth table, truth logic is defined as that “Light existence=TRUE” and “NO light or Dark=FALSE”

FIG. 21: 3^{rd} maximum intensity in double slits light diffraction pattern at “±13.9°”

FIG. 22: 3^{rd} maximum intensity in double slit light diffraction pattern at “±13.9°” shown in flat pattern

FIG. 23: First minimum intensity in single slit light diffraction pattern at “±13.9°”

FIG. 24: First minimum intensity in single slit light diffraction pattern at “±13.9°” shown in flat pattern

FIG. 25: AND logical function slit at “13.9°” of light diffraction pattern

FIG. 26: AND logical function slit truth table, truth logic is defined as that “Light existence=TRUE” and “NO light or Dark=FALSE”

FIG. 27: NOT logical function slit at “3.4°” of light diffraction pattern

FIG. 28: NOT logical function slit truth table, truth logic is defined as that “Light existence=TRUE” and “NO light or Dark=FALSE”

Design Principles:

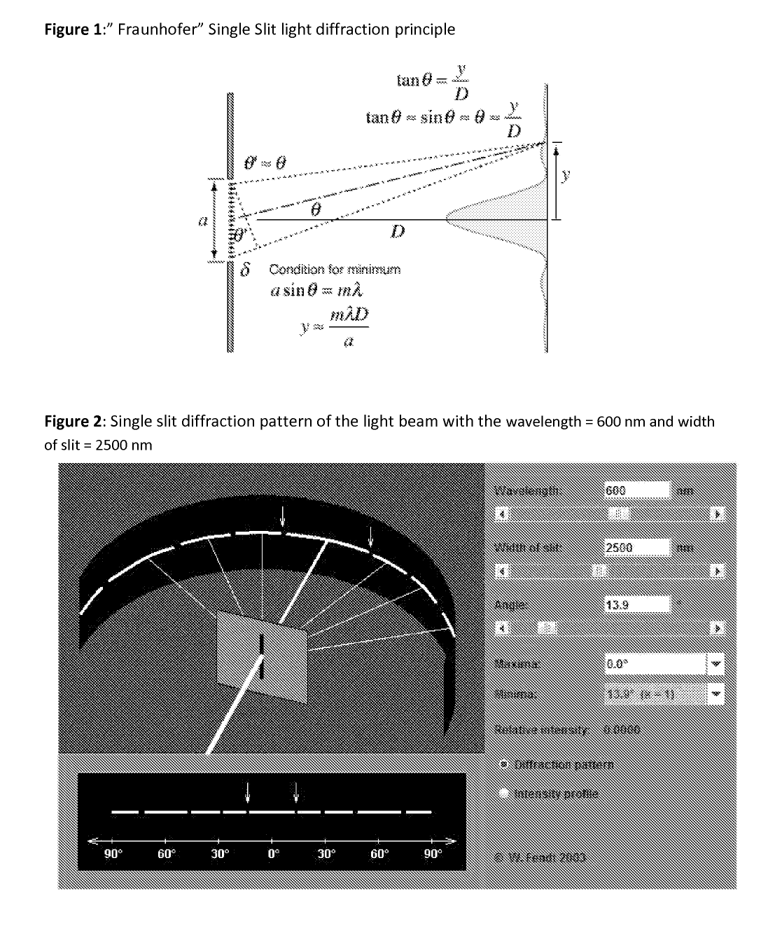

As per “Fraunhofer” Single Slit principle (FIG. 1), the below formula can be used to model the different parameters which effect diffraction through a single slit.

Displacement y=(Order m×Wavelength×Distance D)/(slit width a)

Under the “Fraunhofer” conditions (FIG. 1), the wave arrives at the single slit as a plane wave. Divided into segments, each of which can be regarded as a point source, the amplitudes of the segments will have a constant phase displacement from each other, and will form segments of a circular arc when added as vectors. The resulting relative intensity will depend upon the total phase displacement, “δ” according to the relationship:

$$I = {I}_{0} \frac{{sin}^{2} [ \frac{δ}{2} ]}{[ \frac{δ}{2} ]}$$

$$This total phase angle can be related to the deivation angle Θ by \text{:} δ = \frac{2 π a sin Θ}{λ}$$

$$The intensity as a function of angle Θ is \text{:} I = {I}_{0} \frac{{sin}^{2} [ \frac{π a sin Θ}{λ} ]}{{[ \frac{π a sin Θ}{2} ]}^{2}}$$

So base on these formulas if we propose the wavelength=600 nm and width of slit=2500 nm the first Minima of the intensity would be at angle of “13.9°” as shown in (FIG. 2).

Now Let's Study the Double Slit Interference:

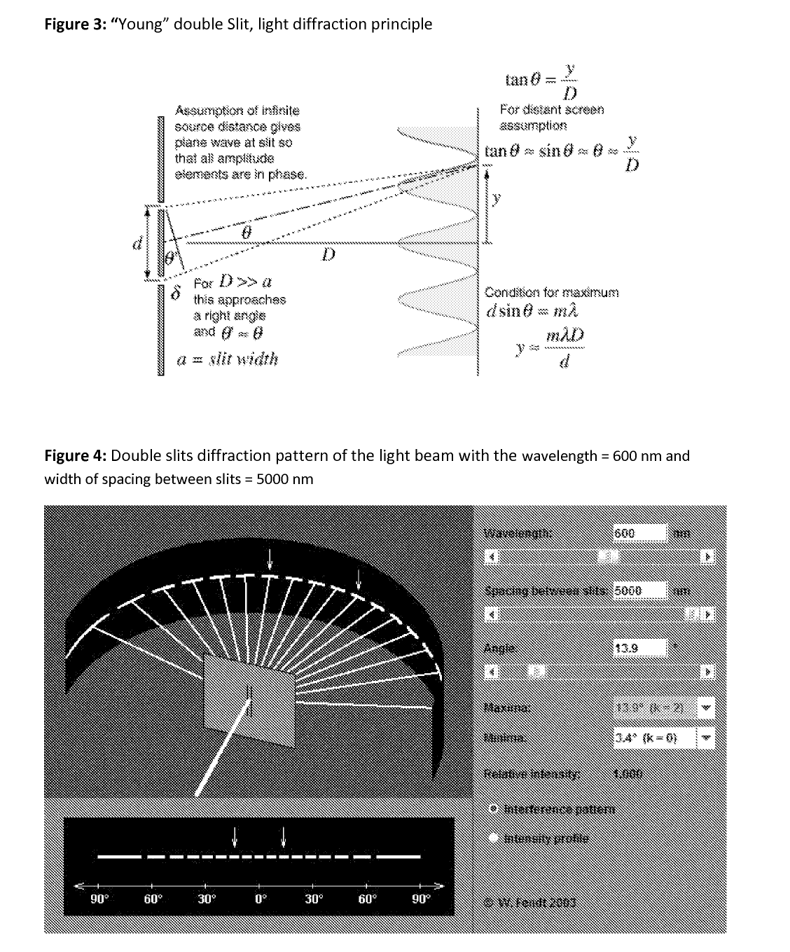

As what shown in (FIG. 3):

Displacement y=(Order m×Wavelength×Distance D)/(slit separation d)

An expression for the intensity of the diffracted light field can be calculated using the Fraunhofer diffraction equation. If the width of the slits is negligible, their separation is “d”, and they are illuminated normally by a plane wave with wavelength “λ”, the intensity variation with angle “θ”, which is the angle subtended by the point “P” at the origin, is given by

I(θ)∝cos²(kd sin θ)

It can be seen that the intensity of the pattern varies as the square of the cosine, thus giving rise to Young's fringes. The spacing of the fringes increases as the separation of the slits decreases. The bright bands observed on the screen happen when the light has interfered constructively—where a crest of a wave meets a crest from another wave. The dark regions show destructive interference—a crest meets a trough. Constructive interference occurs when

d sin θₙ=nλ

and destructive interference occurs when

$$d sin {θ}_{n} = ( n + \frac{1}{2} ) λ$$

Using the paraxial approximation, when θ<10°, that

$$θ \approx sin θ \approx tan θ = \frac{x}{L}$$

, the bright fringes occur when

$$\frac{n λ}{d} = \frac{x}{L} ⇔ n λ = \frac{x d}{L} ,$$

Where:
“n” is the order of maximum observed (central maximum is n=0),
“x” is the distance between the bands of light and the central maximum (also called fringe distance),
“L” is the distance from the slits to the screen center point, and
“θₙ” is the angle between the center point normal and the nth maximum.

A more complete discussion can be found here:

It is possible to work out the wavelength of light using this equation and the above apparatus. If “d” and “L” are known and “x” is observed, then “A” can be easily calculated.

If the width of the slits, “a” is finite, the equation for the diffracted pattern is given by Longhurst as

$$I ( θ ) ∝ {[ \frac{sin ( k a sin θ )}{k a sin θ} ]}^{2} {cos}^{2} [ k sin θ ( d + a ) ]$$

So base on these formulas if we propose the wavelength=600 nm and spacing between slits=5000 nm the 3^{rd} Maxima of the intensity would be again at diffraction pattern angle of “13.9°” as shown in (FIG. 4).

Design Theory:

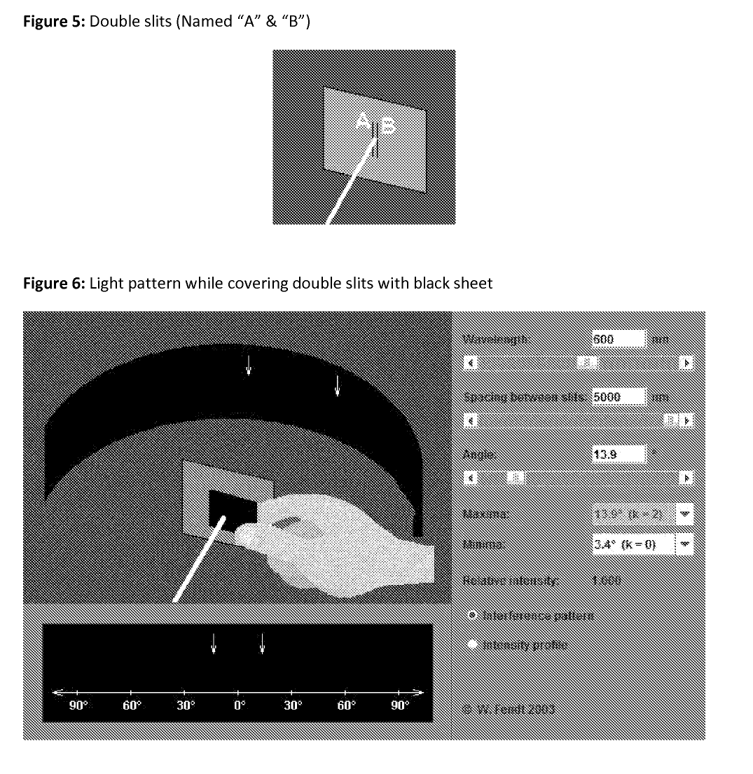

In the double slits interference experiment, if we posit each slit as an input (A and B) for a logical function, as shown in (FIG. 5), and presume the logic state of “0 or FALSE” for “No light beam” and the “1 or TRUE” logic state for “Light beam”, base on the truth table of any 2 inputs logical function, there would be for cases happening as below table:

INPUT

| A | B |
|---|---|
| 0 | 0 |
| 0 | 1 |
| 1 | 0 |
| 1 | 1 |

Which base on our definition of “0” and “1” states as above, this truth table would be translated as below truth table:

INPUT

| | A | B |
|---|---|---|
| 1 | Dark | Dark |
| 2 | Dark | Light |
| 3 | Light | Dark |
| 4 | Light | Light |

Base on above truth table and considering the single and double slit principles as discussed, for each logical state of above truth table the output light pattern would be as below:

### 1—A=B=Dark:

This status happens when we put a black sheet before the both slits, so no light beam would reach them (the Slits), or won't pass through (FIG. 6).

### 2—A=Dark & B=Light

This status happens when we put a black sheet before the “A” slit, so no light beam would reach it or won't pass through. And the diffraction pattern would be base on single slit diffraction pattern (FIG. 7).

### 3—A=Light & B=Dark

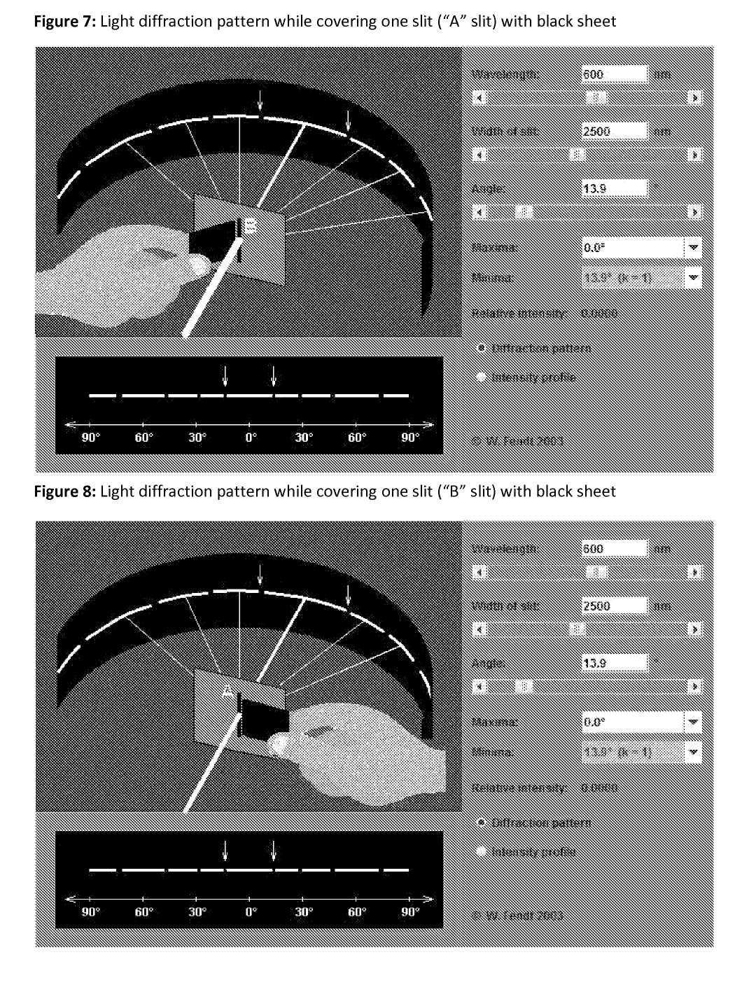

This status is completely the same as the “2” status but with small difference that we have put the black sheet on slit “B” this time, and same as the “2” status the diffraction pattern would follow the single slit diffraction pattern (FIG. 8).

### 4—A=Light & B=Light

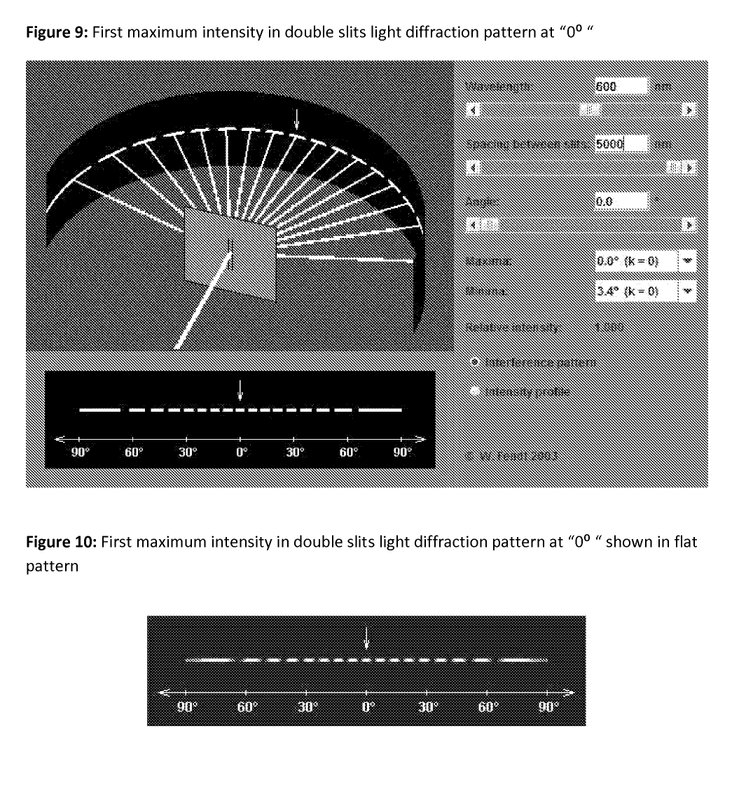

This status happens when both slits are uncovered and the light would pass through the both slits. The diffraction pattern would follow double slit diffraction pattern as discussed above. The diffraction pattern would be as (FIG. 9).

Now if for all patterns (Status), we focus on special points (Angels) of the diffraction pattern, we can find different logical functions derived from this simple method.

OR Logical Function:

As what discussed above for the double slit principle the first Maximum in this type of diffraction, for the wavelength=600 nm and spacing between slits=5000 nm would happen in “0°” and the diffraction pattern would be as (FIG. 9).

As what you may find in (FIG. 9), we have the maximum intensity at the “0°”. This is pointed in (FIG. 10) with the arrow sign.

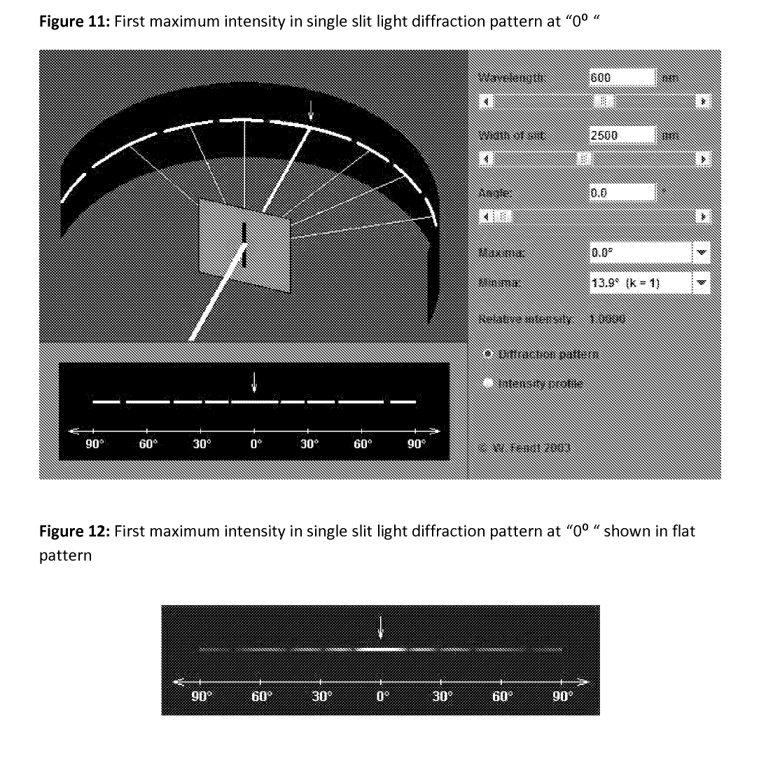

Now considering the single slit diffraction principle as discussed before, the diffraction pattern for wavelength=600 nm and width of slit=2500 nm would be as (FIG. 11).

As what you may find in (FIG. 11), we have the maximum intensity in the “0°”. This is pointed in (FIG. 12) with the arrow sign.

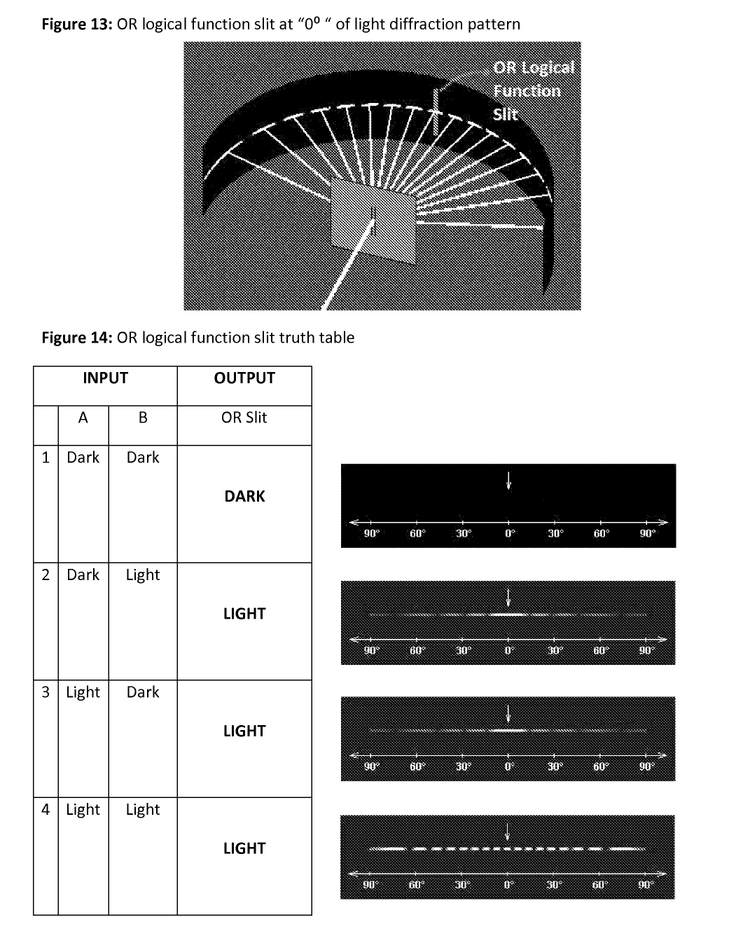

No if we consider that there is a slit at the “0°”, on the screen where the diffraction pattern appears (FIG. 13) The output of this slit acts as the OR Logical function base on (FIG. 14) truth table (Shown in the patterns with the Arrow sign).

This truth table (FIG. 14) shows:
1—When both slits are covered, no light would pass through, and the “0°” point would be also DARK.
2—When only one of the slits are covered “A or B” the situation would be as the single slit diffraction principle, and “0°” point would be Lightened as the first maximum intensity of the diffraction.
3—Situation would be same as “2” status.
4—When both of the slits are uncovered, base on the double slit diffraction principle the “0°” point would be Lightened as the first maximum intensity of the diffraction.

So we have an OR LOGICAL function using the light diffraction patterns and optical devices with no interference of electronic devices.

XOR Logical Function:

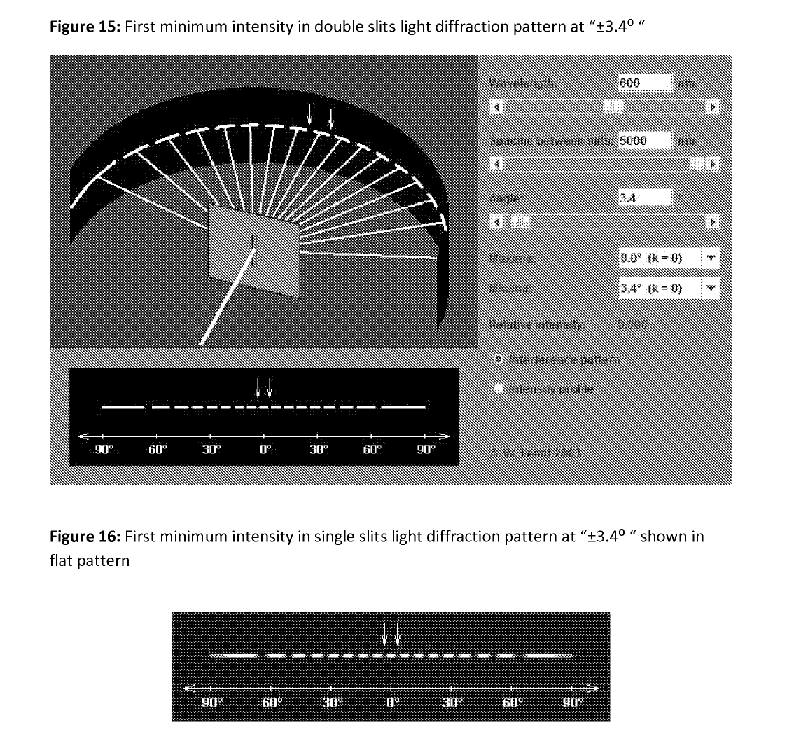

As what discussed for the double slit principle the first Minimum in this type of diffraction for the wavelength=600 nm and spacing between slits=5000 nm would happen in “±3.4°” and the diffraction pattern would be as (FIG. 15).

As what you may find in (FIG. 15), we have the Minimum intensity at the “±3.4°”. This is pointed in (FIG. 16) with the arrow signs.

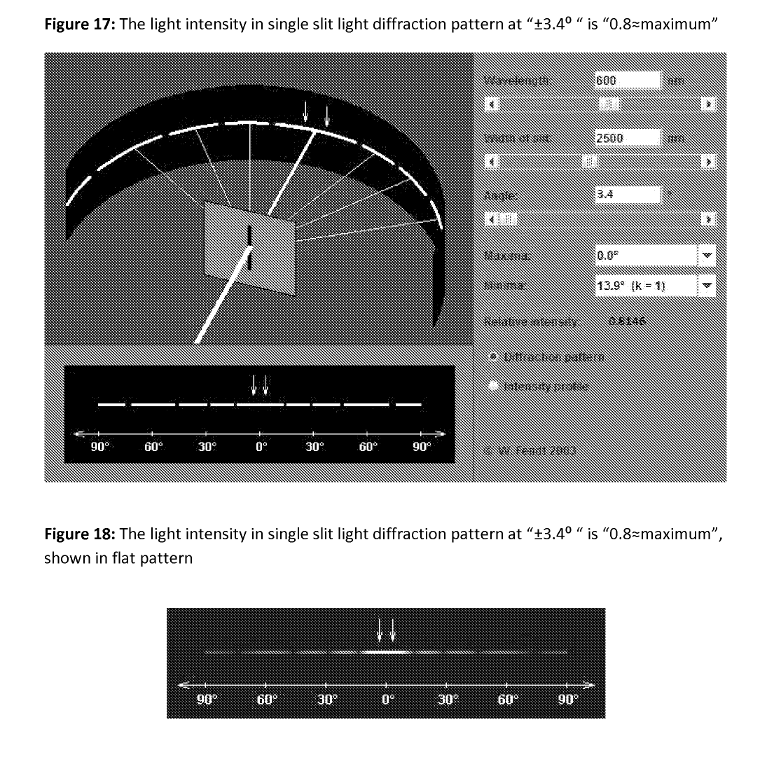

Now considering the single slit diffraction principle as discussed before, the diffraction pattern for wavelength=600 nm and width of slit=2500 nm would be as (FIG. 17). As what you may find in (FIG. 17), the intensity of the diffracted light at “±3.4°” point is about 81% of the Maximum light intensity which can be taken almost equal as a maximum intensity or as a “TRUE” case in logical functions. This is pointed in (FIG. 18), with the arrow signs.

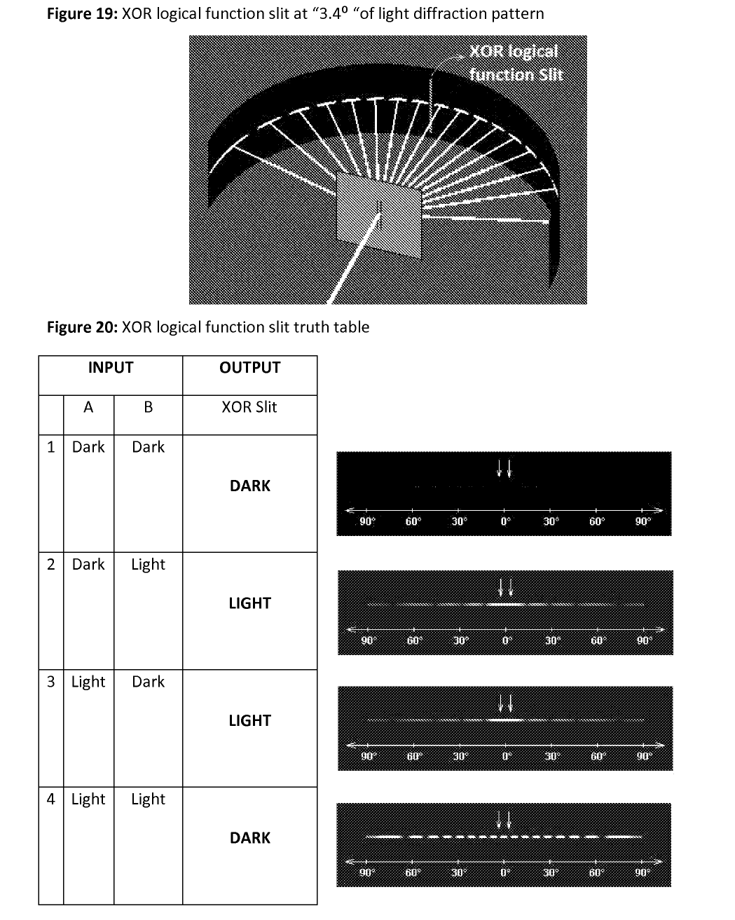

Now if we consider that there is a slit at the “+3.4°”, on the screen where the diffraction pattern appears (FIG. 19), the output of this slit acts as the XOR Logical function base on (FIG. 20) truth table (Shown in the patterns with the Arrow signs):

This truth table (FIG. 20) shows:
1—When both slits are covered, no light would pass through and the “3.4°” point would be also DARK.
2—When only one of the slits are covered “A or B”, base on the single slit diffraction principle, the “3.4°” point would be Lightened with the 81% of maximum intensity of the diffraction which can be taken almost equal as “TRUE” in logical function.
3—Situation is the same as “2” status.
4—When both of the slits are uncovered, base on the double slit diffraction principle the “3.4°” point would be Dark as the first minimum intensity of the diffraction.

So we have a XOR LOGICAL function using the diffraction pattern and optical devices.

AND Logical Function:

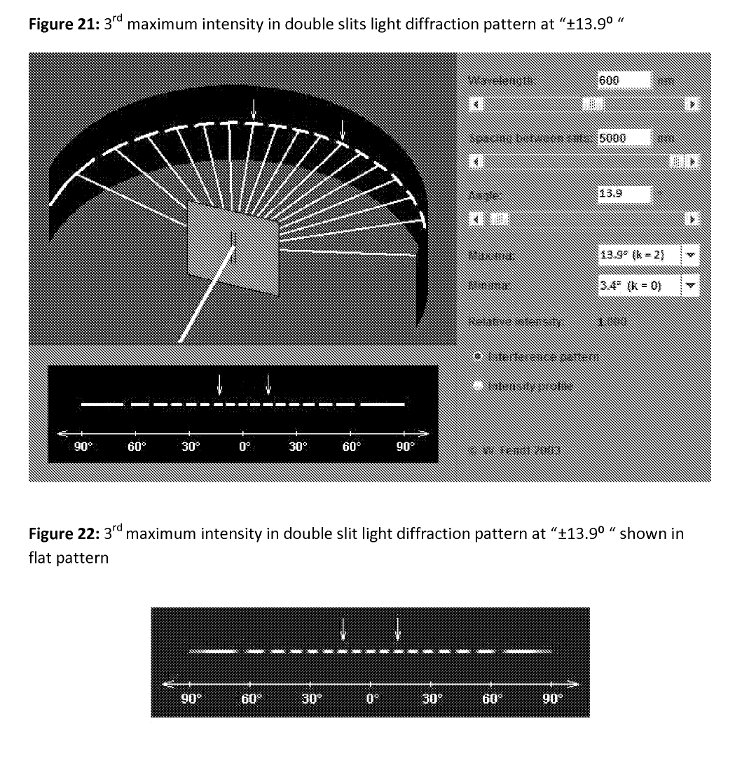

As what discussed for the double slit diffraction principle the 3^{rd} Maximum in this type of diffraction for the wavelength=600 nm and spacing between slits=5000 nm would happen at “±13.9°” and the diffraction pattern would be as (FIG. 21).

As what you may find in (FIG. 21), we have the 3″ Maximum intensity in the “±13.9°”. This is pointed in (FIG. 22), with the arrow signs.

Now considering the single slit diffraction principle as discussed before, the diffraction pattern for wavelength=600 nm and width of slit=2500 nm would be as (FIG. 23).

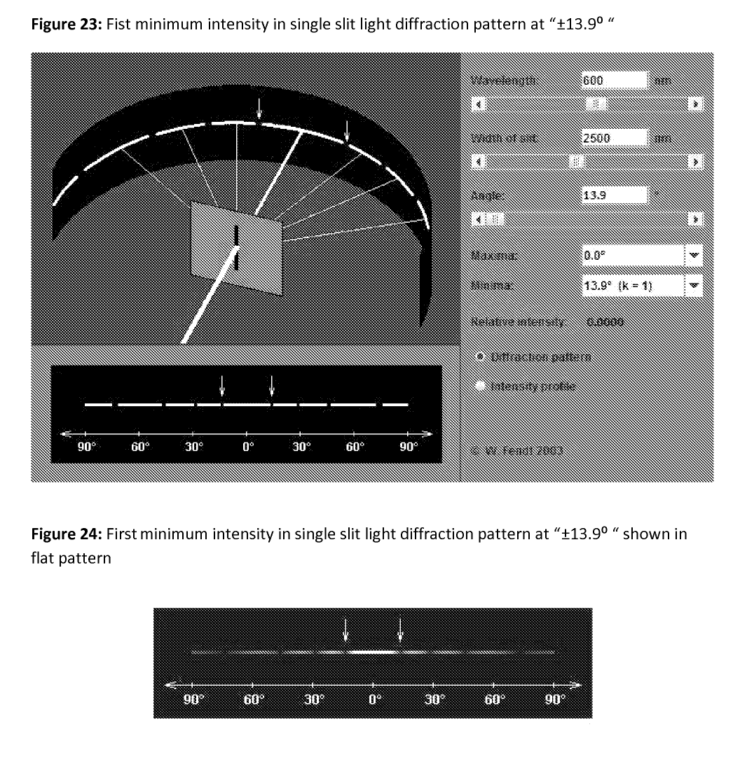

As what you may find in (FIG. 23), we have the first Minimum intensity in the “±13.9°”. This is pointed in (FIG. 24), with the arrow signs.

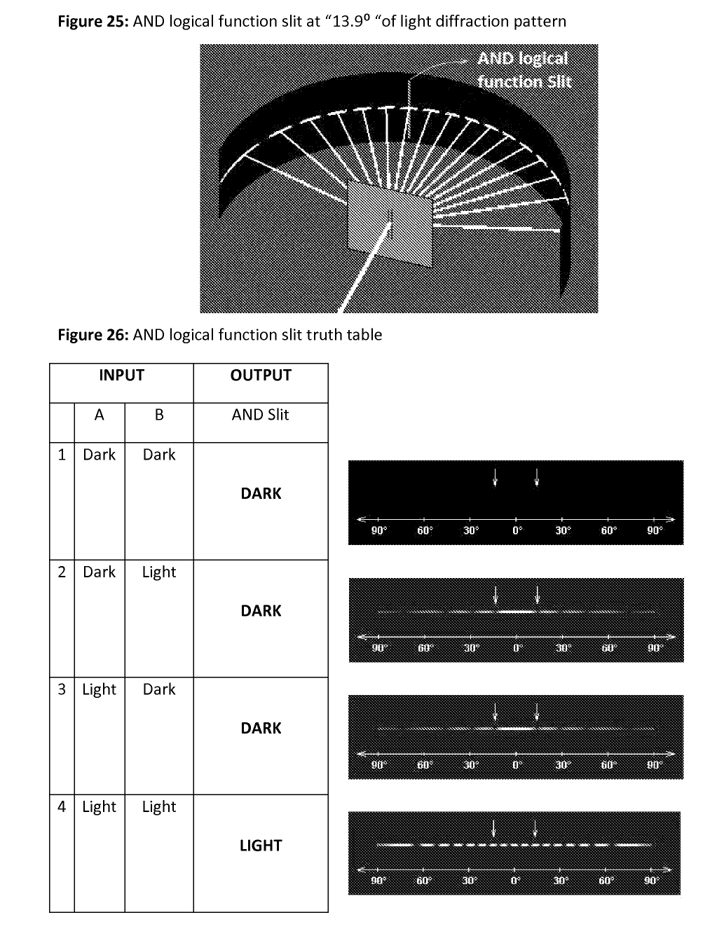

Now if we consider that there is a slit at the “+13.9°”, on the screen where the diffraction pattern appears (FIG. 24), the output of this slit acts as the AND Logical function base on (FIG. 25) truth table (Shown in the patterns with the Arrow sign).

This truth table shows:
1—When both slits are covered, no light would pass through and the “13.9°” point would be also DARK.
2—When only one of the slits are covered “A or B” base on the single slit diffraction principle, the “13.9°” would be Dark as the first minimum intensity of diffraction pattern.
3—Status would be same as “2” status.
4—When both of the slits are uncovered, base on the double slit principle the “13.9°” would be Lightened as the 3″ Maximum intensity of the diffraction.

So we have an AND LOGICAL function using the optical devices.

NOT Logical Function:

Deriving the NOT Logical function through this system is a little bit different as we would have only one logical input (DARK or LIGHT) which should be diverted into output as below truth table:

| INPUT | | OUTPUT |
|---|---|---|
| | A | NOT (A′) |
| 1 | Dark | LIGHT |
| 2 | Light | DARK |

So we would consider the “A” slit as the input for this Logical function but we won't cover the “B” slit, as this input act as the actuator for inverting the “A” input.

As what discussed before for the double slit diffraction principle the first Minimum for the wavelength=600 nm and spacing between slits=5000 nm would happen at “±3.4°” and the diffraction pattern would be as (FIG. 15).

As what you may find in (FIG. 15), we have the first Minimum intensity in the “±3.4°”. This is pointed in (FIG. 16) with the arrow signs.

Now considering the single slit diffraction principle as discussed before, the diffraction pattern for wavelength=600 nm and width of slit=2500 nm would be as (FIG. 17).

As what you may find in (FIG. 17), the intensity of the diffracted light at “±3.4°” is about 81% of the Maximum light intensity which can be taken almost equal as a maximum or as a “TRUE” case in logical function. This is pointed in (FIG. 16) with the arrow signs.

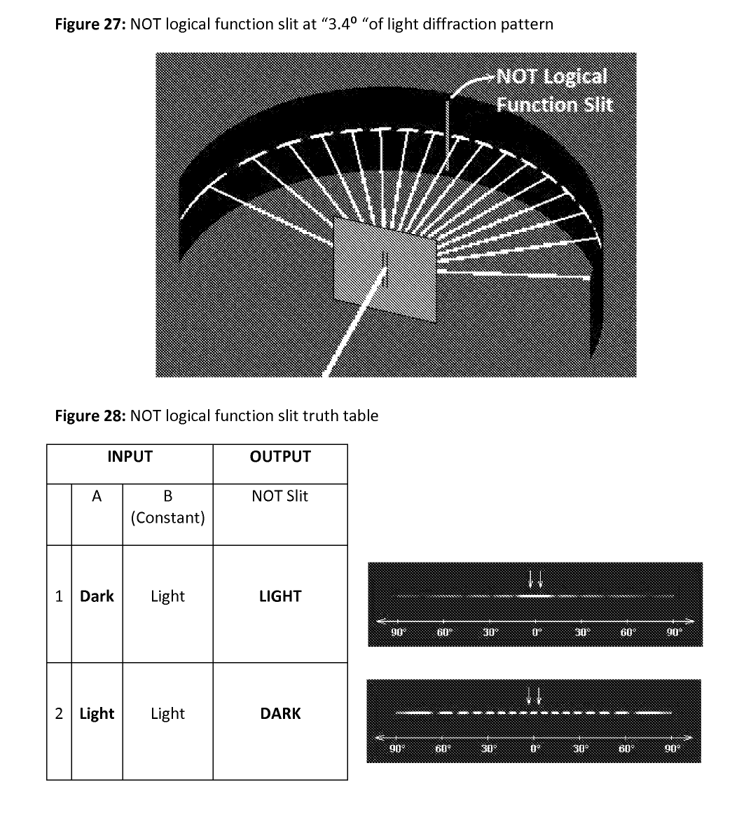

Now if we consider that there is a slit at the “+3.4°”, on the screen where the diffraction pattern appears (FIG. 27), the output of this slit acts as the NOT Logical function.

To have the inverted output of the “A” slit we would have the “B” slit acting as a always constant “TRUE” logic with the “LIGHT” status so we would have the inverted output of “A” input base on (FIG. 28) truth table (Shown in the patterns with the Arrow sign).

This truth table (FIG. 28) shows:
1—When “A” slits is covered but “B” slit is not covered as a “TRUE” constant actuator, the “NOT SLIT” would follow the single slit diffraction pattern, and base on what discussed, the “NOT SLIT” at “3.4°” point would be Lightened.
2—When “A” slits is Uncovered and also “B” slit is not covered as a “TRUE” constant actuator, the “NOT SLIT” would follow the Double slit diffraction pattern and base on what discussed the “NOT SLIT” at “3.4°” point would be Dark as the first minimum intensity of diffraction pattern.

So we have a NOT LOGICAL function using the optical devices.

### REFERENCES

http://www.walter-fendt.de/ph14e/doubleslit.htm
http://www.walter-fendt.de/ph14e/singleslit.htm
http://hyperphysics.phy-astr.gsu.edu/hbase/phyopt/mulslid.html#c2
http://hyperphysics.phy-astr.gsu.edu/hbase/phyopt/fraungeo.html#c1
http://hyperphysics.phy-astr.gsu.edu/hbase/phyopt/sinslit.html#c1
http://hyperphysics.phy-astr.gsu.edu/hbase/phyopt/dslit.html#c1
http://hyperphysics.phy-astr.gsu.edu/hbase/phyopt/sinint.html#c1

1. This invention leads us to Optological gates (AND, OR, XOR & NOT) which run at the light speed, by using the optical equipments with no interference of any electronic circuits or devices, so we would have, very high speed logical gates derived from a coherent light beam.
